(19) United States
(12) Patent Application Publication
(10) Pub. No.: US 2004/0026369 A1
(43) Pub. Date: Feb. 12, 2004

(54) Method of etching magnetic materials

(76) Inventors: Chentsau Ying, Cupertino, CA (US); Xiaoyi Chen, Foster City, CA (US); Padmapani C. Nallan, San Jose, CA (US); Ajay Kumar, Sunnyvale, CA (US)

Correspondence Address: Patent Counsel, Applied Materials, Inc., P.O. Box 450A, Santa Clara, CA, 95052, US

(21) Appl. No.: 10/218,244

(22) Filed: Aug. 12, 2002

(51) Int. Cl. C23F 1/00; B44C 1/22; C03C 15/00; C03C 25/68

(52) U.S. Cl. 216/63

(57) ABSTRACT

A method of etching a layer of magnetic material using a hard mask and an etchant comprising BCl₃. The method finds use in etching magnetic materials during fabrication of magneto-resistive random access memory (MRAM) devices.

### BACKGROUND OF THE INVENTION

1. Field of the Invention

The present invention generally relates to a method for fabrication devices on semiconductor substrates. More specifically, the invention relates to a method of etching magnetic materials.

2. Description of the Related Art

Microelectronic devices are generally fabricated on a semiconductor substrate as integrated circuits wherein various layers of metals are interconnected to one another to facilitate propagation of electronic signals within the device. An example of such a device is a storage element in memories such as magnetoresistive random access memories (MRAM). The MRAM storage element is a multilayer device that is formed from a stack of different layers composed of various magnetic and non-magnetic materials. Such materials comprise magnetic alloys (e.g., permalloy (NiFe), cobalt iron (CoFe), and the like), conductors (e.g., tantalum (Ta), tantalum nitride (TiN), copper (Co), and the like), dielectrics (aluminum oxide (Al₂O₃) and the like), and other layers. These layers are deposited as overlying blanket films, layer-by-layer, and then featured to form a MRAM device.

Fabrication of a MRAM device comprise etching processes in which one or more layers that comprise a film stack are removed, either partially or in total. Many layers in the MRAM device are very thin (e.g., about 10-100 Angstroms) and as such are difficult to etch with no damage to the stack. In the prior art, during etching a MRAM film stack, the etchants may erode the layers of the stack or leave metal-containing residues. These problems arise from low etch selectivity and non-volatile nature of by-products that form during an etch process. Residues that contain metal, metal chlorides, fluorides, oxides and polymers are known in the art. Some residues may build up along the sides of the film stack and form a conductive veil-like pattern. The veil or eroded layers can cause electrical short-circuits within the MRAM device, e.g., between the magnetic layers that are separated by a very thin tunnel layer of dielectric material. The residues may also contaminate any additional layers that are formed to provide an electrical connection for the MRAM film stack to wiring lines within the integrated circuit.

Therefore, there is a need in the art for a method of etching magnetic materials for fabrication of a magneto-resistive random access memory (MRAM) device.

### SUMMARY OF THE INVENTION

The present invention is a method for etching magnetic materials. The method may be used for fabrication of a magneto-resistive random access memory (MRAM) device comprising a MRAM film stack that is formed on a semiconductor substrate. The method comprises forming a hard mask upon a film stack that comprises a layer of magnetic material, then etching the layer of magnetic material using a plasma comprising BCl₃

### BRIEF DESCRIPTION OF THE DRAWINGS

So that the manner in which the above recited features of the present invention are attained and can be understood in detail, a more particular description of the invention, briefly summarized above, may be had by reference to the embodiments thereof which are illustrated in the appended drawings.

FIGS. 1A and 1B together depict a flow diagram of an example of the present invention;

FIGS. 2a-2o depict a sequence of schematic, cross-sectional views of a substrate having a MRAM stack being formed in accordance with an example of the present invention;

FIG. 3 depicts a schematic, cross sectional view of an etch reactor;

FIG. 4 depicts a schematic, cross sectional view of a wet cleaning module; and

FIG. 5 depicts a schematic, plan view of an integrated platform used to perform the method of the present invention.

To facilitate understanding, identical reference numerals have been used, where possible, to designate identical elements that are common to the figures.

It is to be noted, however, that the appended drawings illustrate only typical embodiments of this invention and are therefore not to be considered limiting of its scope, for the invention may admit to other equally effective embodiments.

### DETAILED DESCRIPTION

The present invention is a method of etching a layer of magnetic material for fabrication of a magneto-resistive random access memory (MRAM) device comprising a MRAM film stack that is formed on a semiconductor substrate (also referred to herein as a wafer). The MRAM film stack comprises a top electrode (e.g., tantalum (Ta), tantalum nitride (TaN), and the like), a free magnetic layer (NiFe, CoFe, and the like), a tunnel layer (e.g., Al₂O₃ and the like), a multi-layer magnetic stack comprising layers of NiFe, ruthenium (Ru), CoFe, PtMn, NiFe, NiFeCr and the like, a bottom electrode layer (e.g., Ta, TaN, and the like), and a barrier layer (e.g., SiO₂ and the like).

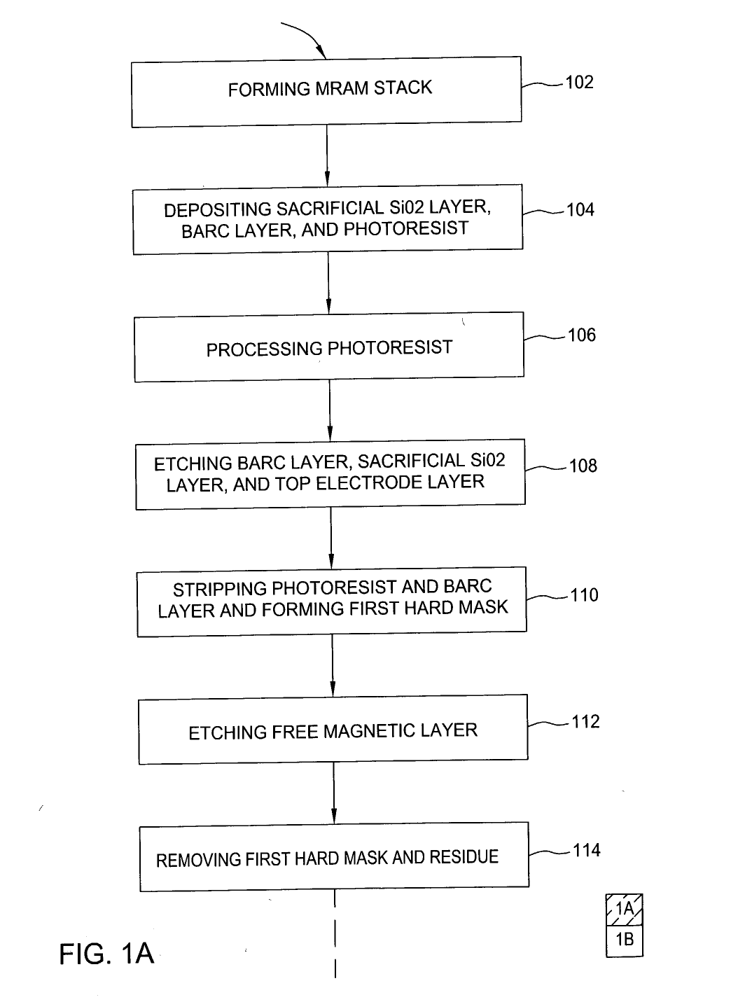

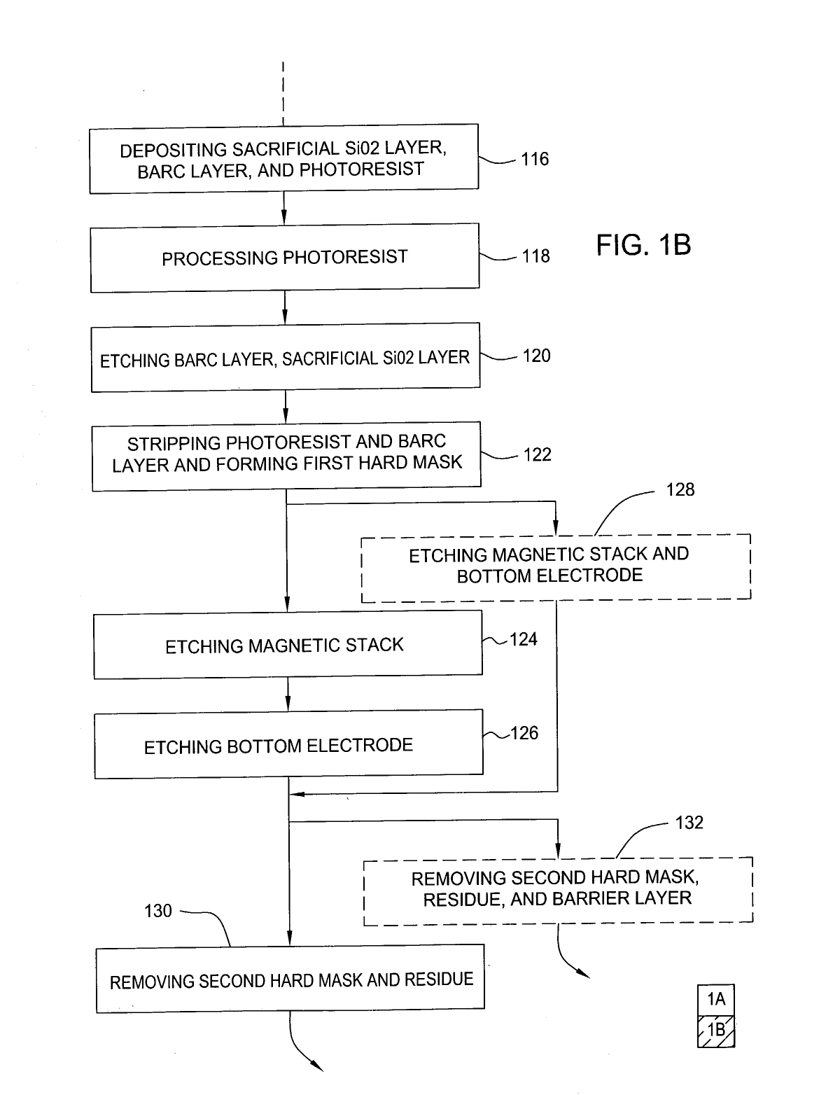

FIGS. 1A and 1B together depict a flow diagram of one embodiment of the inventive method as a sequence 100. The sequence 100 comprises the processes that are performed upon a MRAM film stack during fabrication of the MRAM device.

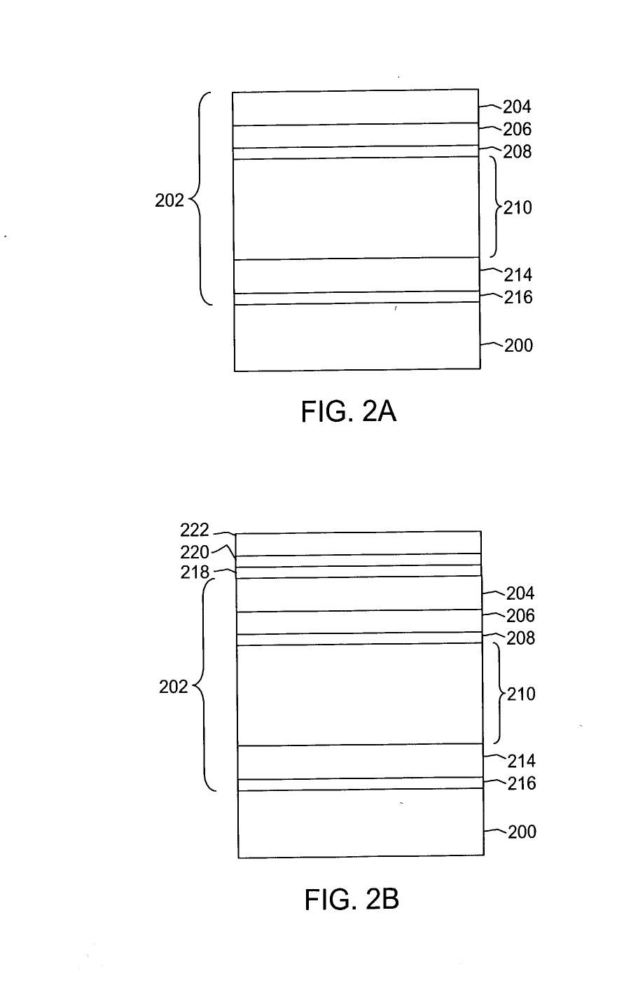

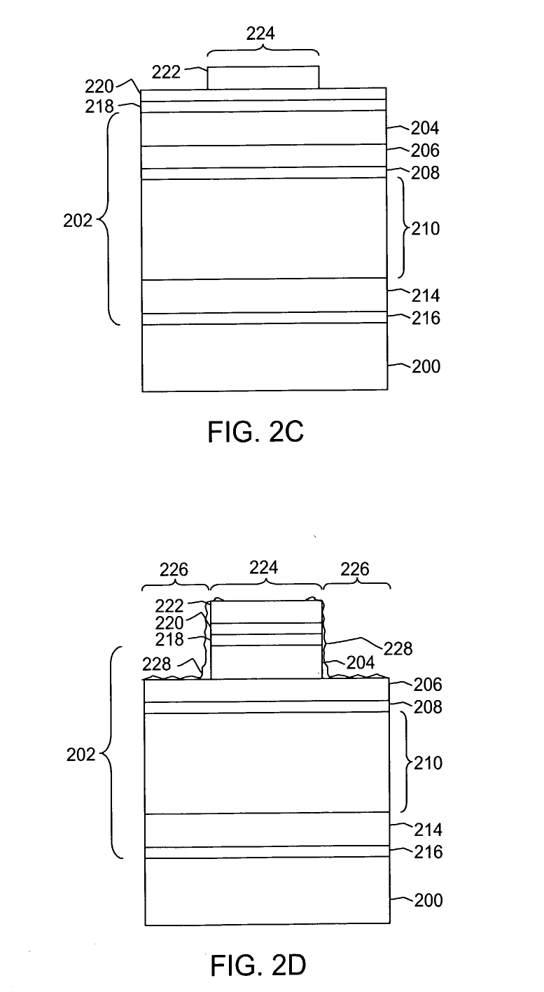

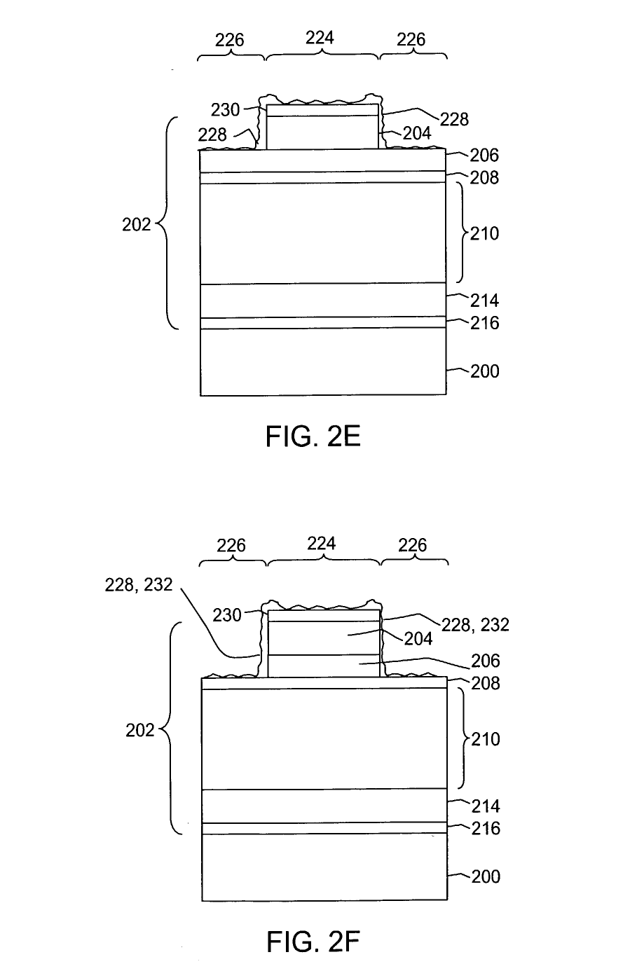

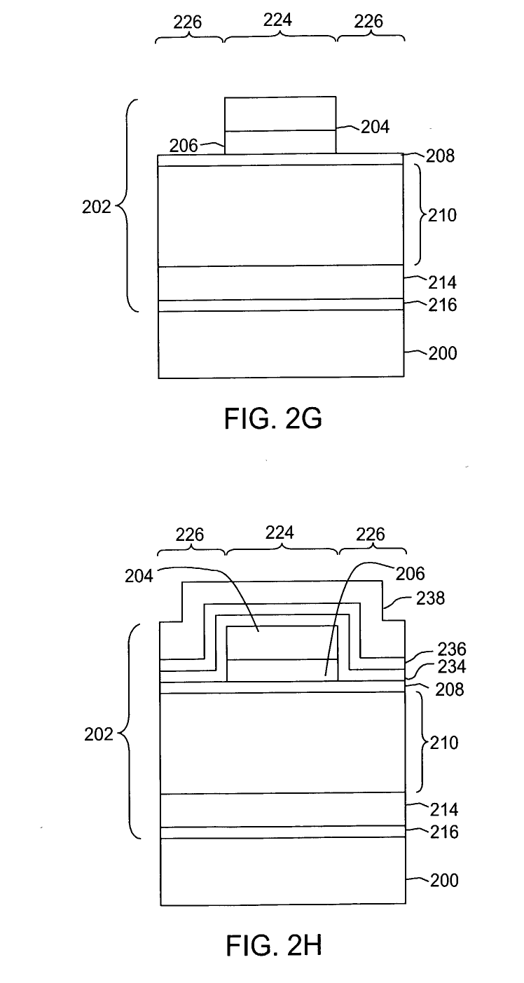

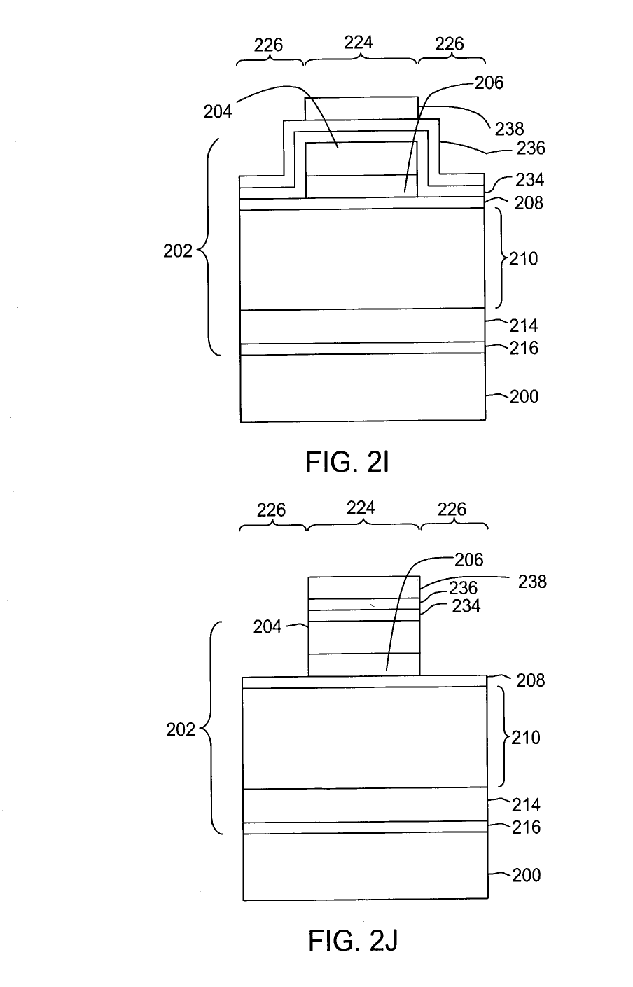

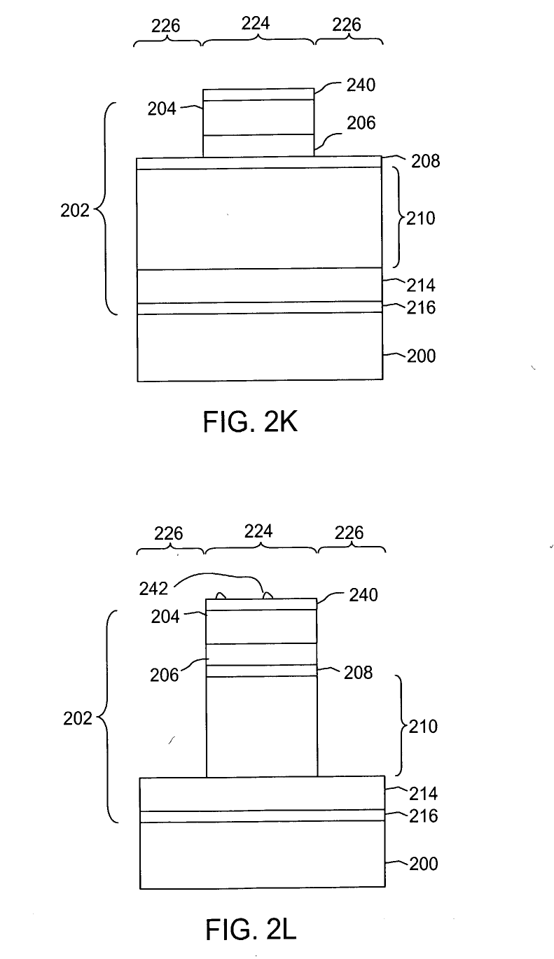

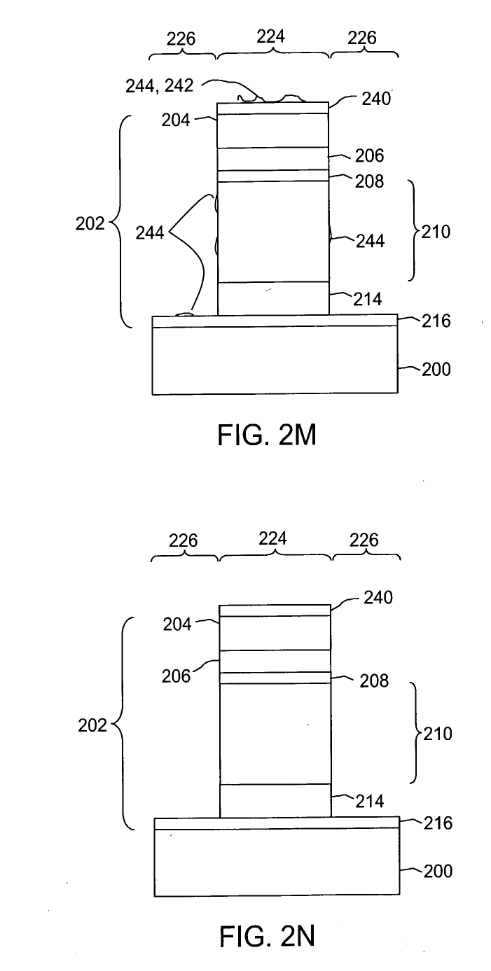

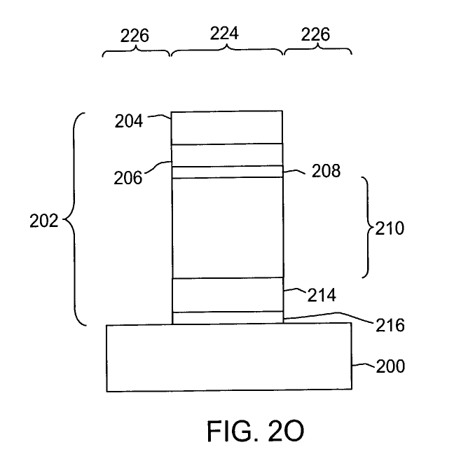

FIGS. 2a-2o depict a sequence of schematic cross-sectional views of a substrate comprising a MRAM device being formed therein using the sequence 100. To best understand the invention, the reader should simultaneously refer to FIGS. 1A, 1B, and 2a-2n. The cross-sectional views in FIGS. 2a-2o relate to individual process steps that are used to form the device. Sub-processes and lithographic routines (i.e., exposure and development of photoresist, and the like) are not shown in FIGS. 1A, 1B and FIGS. 2a-2n. The images in FIGS. 2a-2o are not depicted to scale and are simplified for illustrative purposes.

The sequence 100 begins, at step 102, by forming a MRAM film stack 202 on a wafer 200 (FIG. 2a). In one embodiment, the stack 202 comprises a top electrode layer 204, a free magnetic layer 206, a tunnel layer 208, a multi-layer magnetic stack 210, a bottom electrode layer 214, and a barrier layer 216. In one exemplary embodiment, the magnetic stack 210 is a multi-layer stack that comprises layers of CoFe, Ru, CoFe, PtMn, NiFe, NiFeCr having a thickness of about 8, 20, 200, 10, and 30 Angstroms, respectively. Alternatively, in the magnetic stack 210, a PtMn may be replaced by an IrMn layer. The tunnel layer 208 is formed, for example, from alumina (Al₂O₃) or the like dielectric material to a thickness of about 10 Angstroms. The tunnel layer 208 is sandwiched between the free magnetic layer 206 and the magnetic stack 210 to form a magnetic tunnel junction of the MRAM device. The layer 206 is formed, for example, from materials such as nickel and cobalt iron alloys such as CoFe, NiFe, and the like. The layer 206 may consist of one or more sub-layers or a combination of such alloys and generally has a total thickness of about 20-200 Angstroms. In one example, the top electrode 204 and the bottom electrode layer 214 are formed from tantalum (Ta), tantalum nitride (TaN), and the like conductors to a thickness of about 200-600 Angstroms. The barrier layer 216 is formed, for example, from silicon dioxide (SiO₂) to a thickness of about 10-50 Angstroms.

It should be understood, however, that the film stack 202 and the magnetic stack 210 may comprise layers formed from other materials or layers having a different thickness.

The layers that comprise the stack 202 may be deposited using a vacuum deposition technique such as an atomic layer deposition (ALD), a physical vapor deposition (PVD), a chemical vapor deposition (CVD), evaporation, and the like. Fabrication of the MRAM devices may be performed using the respective processing modules of CENTURA®, ENDURA®, and other semiconductor wafer processing systems available from Applied Materials, Inc. of Santa Clara, Calif. and others.

At step 104, a sacrificial layer 218, a bottom anti-reflective coating (BARC) layer 220, and a photoresist layer 222 are sequentially formed atop the film stack 202 (FIG. 2b). The layers 218, 220, and 222 may be formed using conventional deposition and lithographic routines. In one example, the sacrificial layer 218 is formed from silicon dioxide (SiO₂) to a thickness of about 500 Angstroms. The BARC layer 220 is positioned between the photoresist layer 222 and the sacrificial layer 218 and controls the reflection of light from the layer 218 during exposure of the photoresist. As a feature size is reduced, inaccuracies in a pattern transfer process can arise from optical limitations inherent to the lithographic process such as light reflection. The BARC layer 220 may be composed, for example, from inorganic materials such as silicon nitride, silicon oxynitride, titanium nitride, silicon carbide, and the like, or organic materials such as polyamides and polysulfones. The layers 220 and 222 together have a thickness of about 6000 Angstroms. In some applications, the BARC layer may not be necessary. As such, the BARC layer is considered optional.

At step 106, the photoresist layer 222 is processed using a conventional lithographic patterning routine, i.e., photoresist is exposed through a mask, developed, and the undeveloped photoresist is removed. The developed photoresist is generally a carbon-based polymer that remains as an etch mask only on top of the stack 202 in the region 224 that should to be protected during an etch process (FIG. 2c).

At step 108, the BARC layer 220, the sacrificial layer 218, and the top electrode 204 are plasma etched using either a chlorine-based or fluorine-based chemistry (e.g., CF₄/CHF₃/Ar and the like). Step 108 removes the layers 220, 218, and 204 in the unprotected regions 226. In one embodiment, step 108 uses the free magnetic layer 206 as an etch stop layer. Alternatively, the process time during step 108 can be terminated upon a certain optical emission occurring (e.g., at wavelength of about 3630 Angstroms), upon a particular duration occurring, or upon some other indicator determining that the top electrode layer 204 has been removed in the regions 226. During step 108, some amount of the etched metal (e.g., tantalum) from the layer 204 may combine with components (for example, chlorine (Cl₂) or fluorine(F)) of the etchant and by-products of the etching process and form a residue 228. The residue 228 contaminates the sidewalls of the BARC layer 220, the sacrificial layer 218, and may rest elsewhere on the wafer 200 (FIG. 2d).

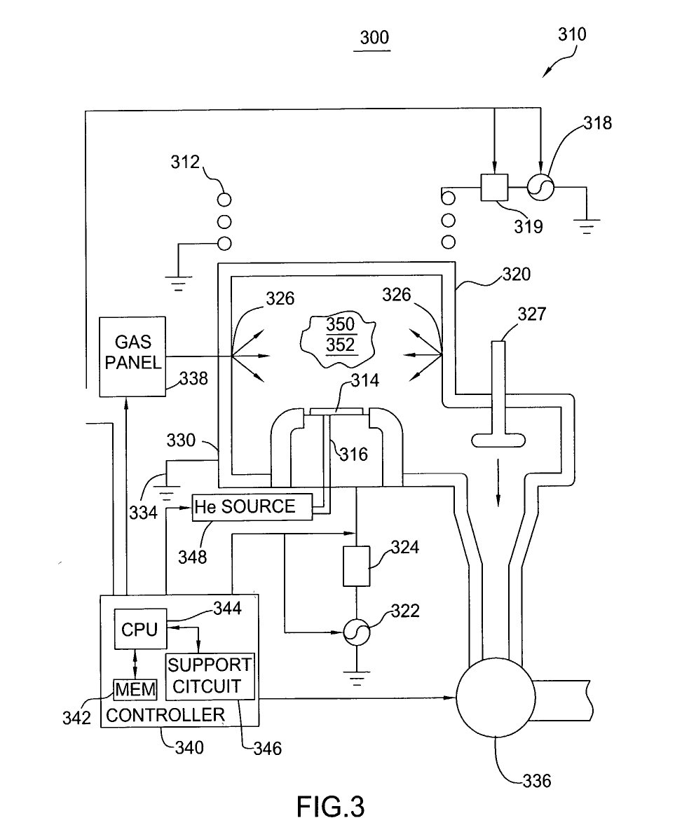

Step 108 can be performed in an etch reactor such as a Decoupled Plasma Source (DPS) II module of the CENTURA® system. The DPS II module uses a 2 MHz inductive plasma source to generate and sustain high density plasma. A wafer is biased by a 13.56 MHz bias source. The decoupled nature of the plasma source allows independent control of ion energy and ion density. The DPS II module provides a wide process window over changes in source and bias power, pressure, and etch gas chemistry and uses an endpoint system to determine an end of the etch process. The DPS II module is disclosed in detail with respect to FIG. 3 below.

In one embodiment, step 108 etches the layers 220, 218, and 204 in the DPS II module by supplying to the module between 40 and 80 sccm of CF₄, between 10 and 30 sccm of CHF₃, between 40 and 80 sccm of Ar, applying power to an inductively coupled antenna between 200 to 3000 Watts, applying a cathode electrode bias power between 0 to 300 Watts, and maintaining a wafer temperature between 15 to 80 degrees Celsius and a pressure in the reactor between 5 to 40 mTorr. One specific process recipe provides 60 sccm of CF₄, 20 sccm of CHF₃, 60 sccm of Ar, applying 1000 Watts to the antenna and 50 Watts to the cathode electrode, and maintaining a wafer temperature at 80 degrees Celsius and a pressure in the reactor at 10 mTorr.

At step 110, the photoresist layer 222 and the BARC layer 220 are removed, or stripped, and the underlying portion of the sacrificial layer 218 forms a first hard mask 230 (FIG. 2e). After step 110, the first hard mask 230 stays on top of the stack 202 and the residue 228 is partially removed. However, some amount of the residue 228 may remain on the sidewalls of the mask 230, the top electrode 204, and may extend to the top of the mask 230 to form a conductive veil.

The stripping process of step 110 may be performed, for example, in the Advanced Strip and Passivation (ASP) module of the CENTURA® system. The ASP module is a microwave downstream oxygen plasma reactor in which the plasma is confined to a plasma tube and only reactive neutrals are allowed to enter a process chamber. Such a plasma confinement scheme precludes plasma-related damage of the substrate or circuits formed on the substrate. In a processing chamber of the ASP module, the wafer backside is heated radiantly by quartz halogen lamps and wafer temperature can be maintained between 20 to 400 degrees Celsius. A duration of a stripping process is generally between 30 and 120 seconds.

In one embodiment, step 110 removes the layers 222 and 220 in the ASP chamber by supplying between 1000 and 3500 sccm of O₂ and between 0 and 500 sccm of N₂ (corresponds to a flow ratio of about O₂:N₂=7:1), applying between 200 to 3000 Watts to excite a plasma, applying a cathode electrode bias power between 0 to 100 Watts, and maintaining a wafer temperature between 100 to 400 degrees Celsius and a pressure in the reactor between 1 to 10 Torr. In this embodiment, the best results were observed with the oxygen-based reactant gas. One specific process recipe provides 3500 sccm of O₂, 500 sccm of N₂, applies 1400 Watts to excite a plasma, and maintains the wafer temperature at 200 degrees Celsius and a pressure in the reactor at 2 Torr.

Alternatively, step 110 may be performed in the DPS II module. In one embodiment, in the DPS II chamber, step 110 removes the layers 222 and 220 by supplying between 10 and 100 sccm of O₂, between 10 and 100 sccm of N₂, applying power to an inductively coupled antenna about 1000 Watts, applying a cathode electrode bias power about 10 Watts, and maintaining a wafer temperature about 40 degrees Celsius and a pressure in the reactor about 32 mTorr. In this embodiment, a duration of the stripping process is between 30 and 120 seconds.

At step 112, the free magnetic layer 206 (e.g., CoFe, NiFe and the like) is plasma etched using an oxygen and chlorine based chemistry, for example, Cl₂/Ar/O₂ and the like. In such chemistry, oxygen improves selectivity of the etchant to Al₂O₃. In one embodiment when the tunnel layer 208 is formed from Al₂O₃, step 112 uses the layer 208 as an etch stop layer. Step 112 entirely removes the layer 206 from the unprotected regions 226 (FIG. 2f). However, during step 112, the metal from magnetic alloys layers (e.g., CoFe, NiFe, and the like) that form the layer 206 may combine with components of the etchant and by-products of the etch process to form a conductive residue 232. The residue 232 may form a conductive veil upon the sidewalls of the layer 206 and hard mask 230, top of the hard mask 230, and elsewhere on the wafer 200. During step 112, the residue 232 may combine with the remaining after step 110 residue 228 (FIG. 2f). The conductive residues 228 and 232 represent a contaminant with respect to further fabrication of the MRAM device and should be removed before the process 200 may continue.

Step 112 may be performed, in a DPS II module. In one embodiment, step 112 etches the CoFe/NiFe layer 206 in the DPS II module supplying between 5 and 50 sccm of O₂ and between 10 and 100 sccm of Cl₂ (corresponds to a flow ratio of about Cl₂:O₂=2:1), between 10 and 100 sccm of Ar, applying power to an inductively coupled antenna between 200 to 3000 Watts, applying a cathode electrode bias power between 0 to 300 Watts, and maintaining a wafer temperature between 15 to 85 degrees Celsius and a pressure in the reactor between 5 to 40 mTorr. One specific process recipe provides 20 sccm of O₂, 40 sccm of Cl₂, 20 sccm of Ar, applying 700 Watts to the antenna and 100 Watts to the cathode electrode, and maintaining a wafer temperature at 40 degrees Celsius and a pressure in the reactor at 5 mTorr.

At step 114, the first hard mask 230 and the metal-containing residues 228 and 232 are removed using a buffered oxide etch (BOE) process followed by a rinse in distilled water (FIG. 2g). In one exemplary embodiment, the BOE process comprises a wet dip of the wafer 200 in a solution of hydrogen fluoride (HF), ammonium fluoride (NH₄F), and deionized water (DI). After the wet dip in the HF/DI solution, the wafer 200 is rinsed in distilled water to remove any remaining traces of the BOE etchant. In one embodiment, step 114 applies a solution of hydrogen fluoride in NH₄F comprising between 1 and 49% of hydrogen fluoride by volume, at a temperature between 10 and 30 degrees Celsius, for a duration between about 10 and 20 seconds, though longer exposures of up to about 120 seconds may be used. One specific process recipe provides a ratio by volume of ammonium fluoride to hydrogen fluoride of about 6:1 at a temperature of 15 degrees Celsius, for a duration of 10 seconds. The removal of the sacrificial layer (hard mask 230) facilitates removal of the residue that was formed upon the mask.

At step 116, similar to step 104, a sacrificial layer 234 (e.g., SiO₂), a BARC layer 236 (the layer 236 is an optional layer as discussed above in reference to the layer 220), and a photoresist layer 238 are sequentially formed to produce conformal layers upon the patterned top electrode 204 (e.g., Ta, TaN, and the like) as depicted in FIG. 2h.

At step 118, similar to step 106, the photoresist layer 238 is processed using a conventional lithographic patterning routine, i.e., photoresist is exposed through a mask, developed, and the undeveloped photoresist is removed. (FIG. 2i). The developed photoresist remains as an etch mask in the region 224 that should be protected during the consecutive etch processes.

At step 120, the BARC layer 236 and the sacrificial layer 234 are plasma etched using either a chlorine-based (e.g., Cl₂, HCl, and the like) or fluorine-based chemistry (e.g., CF₄/CHF₃/Ar and the like) as described with respect to step 108. During step 120, the layers 236 and 234 are removed from the unprotected regions 226 (FIG. 2j). In one embodiment, step 120 may use either the tunnel layer 208 (as shown in FIG. 2j) or, alternatively, the top layer (e.g., CoFe, NiFe, and the like) of the magnetic stack 210 as an etch stop layer. However, the tunnel layer 208 is so thin (e.g., about 10 Angstroms) that, during step 120, it may be removed (partially or totally) in the regions 226 (not shown). In contrast to step 108, step 120 does not etch a metallic layer (e.g., the layer 204) and, therefore, step 120 does not leave a metal-containing residue upon the stack 202.

At step 122, similar to step 110, the photoresist layer 238 and the BARC layer 236 are removed, or stripped, and the underlying portion of the sacrificial layer 234 forms a second hard mask 240 (FIG. 2k). Similar to step 120, step 122 does not leave a metal-containing residue that may short the tunnel layer 208, the free magnetic layer 206, and the top electrode 204.

At step 124, the magnetic film stack 210 is etched using, a boron chloride (BCl₃) chemistry (for example, Ar/BCl₃ and the like) as an etchant. In one example, the stack 210 comprises, from top to bottom, layers of CoFe, Ru, CoFe, PtMn or IrMn, NiFe, and NiFeCr that are sandwiched between the tunnel layer 208 and the bottom electrode layer 214. In one embodiment, step 124 etches the magnetic film stack 210 using the hard mask 240 (e.g., SiO₂) as an etch mask and the bottom electrode 214 as an etch stop layer (FIG. 2l).

Step 124 may be performed in a DPS II module by supplying between 5 and 25 sccm of BCl₃ and between 20 and 100 sccm of Ar (corresponds to a flow ratio of about BCl₃:Ar=1:4), applying power to an inductively coupled antenna between 200 to 3000 Watts, applying a cathode electrode bias power between 0 to 300 Watts, and maintaining a wafer temperature between 15 to 80 degrees Celsius and a pressure in the reactor between 5 to 40 mTorr. One specific process recipe provides 20 sccm of BCl₃, 80 sccm of Ar, applying 700 Watts to the antenna and 150 Watts to the cathode electrode, and maintaining a wafer temperature at 80 degrees Celsius and a pressure in the reactor at 5 mTorr.

During step 124, some by-products of the etching process that have a low volatility may produce a metal-containing residue 242 on the sidewalls of the film stack 202 and sidewalls and top of the second hard mask 240. The Ar/BCl₃ plasma chemistry in-situ removes the residue 242 from the sidewalls, however, a conductive veil may remain on top of the second hard mask 240. Nevertheless, the residue 242 is not detrimental to performing the next step (step 126) of the sequence 100.

At step 126, the bottom electrode layer 214 is plasma etched using a C ₂ based etchant such as Cl₂/Ar and the like. In one embodiment, step 126 etches the bottom electrode layer 214 using the hard mask 240 (e.g., SiO₂) as an etch mask and the barrier layer 216 (e.g., SiO₂) as an etch stop layer (FIG. 2m). The etch process may be performed in a DPS II module of the Centura® system by supplying between 10 and 100 sccm of Cl₂ and between 10 and 100 sccm of Ar, applying power to an inductively coupled antenna between 200 to 3000 Watts, applying a cathode electrode bias power between 0 to 300 Watts, and maintaining a wafer temperature between 15 to 80 degrees Celsius and a pressure in the reactor between 5 to 40 mTorr. One specific process recipe provides 45 sccm of Cl₂, 45 sccm of Ar, applying 700 Watts to the antenna, applying 25 Watts to the cathode electrode, and maintaining a wafer temperature at 80 degrees Celsius and a pressure in the reactor at 10 mTorr.

Step 126 may leave a conductive residue 244 (e.g., containing tantalum) on the sidewalls of the film stack 202 and sidewalls and top of the second hard mask 240, including a conductive veil on top of the of the second hard mask 240 and elsewhere on the wafer 200. Similar to the residues 228 and 232, the residues 242 and 244 may combine together. The step 126 residue(s) should be removed prior to completion of the process 200.

Steps 124 and 126 may be performed in-situ, i.e., in the same etch reactor or the steps may be performed sequentially in the dedicated reactors. Alternatively, at step 128, the magnetic film stack 210 and the bottom electrode layer 214 may be plasma etched using a Cl₂ based chemistry (for example, Cl₂/Ar and the like) as an etchant. Step 128 consecutively etches through the layers of the magnetic film stack 210 and the bottom electrode layer 214. In one embodiment, step 128, similar to step 126, uses the hard mask 240 (e.g., SiO₂) as an etch mask and the barrier layer 216 (e.g., SiO₂) as an etch stop layer. Step 126 may be performed, for example, in a DPS II module of the Centura® system using the process recipe as described in reference to step 124. Step 128, similar to step 126, may leave a conductive residue (e.g., comprising tantalum) that should be removed prior to completion of the process 200.

At step 130, the metal-containing residues 242 and 244 are removed using a process that comprises applying the NH₄OH/H₂O₂/H₂O solvent followed by a rinse in distilled water (FIG. 2n). In one embodiment, the solvent comprises, by weight, about (0.1-10) parts of ammonium hydroxide (NH₄OH), (0.1-10) parts of hydrogen peroxide (H₂O₂), and (1-100) parts of deionized water (H₂O). The NH₄OH/H₂O₂/H₂O solvent under the trade name of SC1 is available from Rhodia, Inc., Freeport, Texas and other suppliers. After applying the SC1 solvent, the wafer 200 is rinsed in distilled water to remove any remaining traces of the solvent. Step 132 applies the solvent at a temperature between about 45 and 65 degrees Celsius for a duration between about 30 and 120 seconds. One specific solvent recipe comprises 1 part of NH₄OH, 1 part H₂O₂, and 10 parts of DI water. Step 130 deliberately does not remove the second hard mask 240 and the barrier layer 216 which generally are used during an integration of the MRAM device, fabricated using the sequence 100, into a MRAM memory cell structure.

Alternatively, at optional step 132, the second hard mask 240 and the exposed portion of the barrier layer 216 are removed using a buffered oxide etch (BOE) process followed by a rinse in distilled water (FIG. 2o). In one example, step 132 uses a process recipe that is described above in reference to step 114. Step 132 is used when integration of the fabricated MRAM device into the MRAM memory cell structure does not benefit from a use of the layers 240 and 216.

The MRAM device operates by applying a voltage across the electrodes 204 and 214 to set the direction of the magnetic moments in the free magnetic layer 206. The layer of PtMn is a “pinning” layer that sets (or pins) the direction of the magnetic moments of the magnetic film stack 210 (the “pinned” layer). Depending on whether the direction of moments in the free magnetic layer 206 are aligned with the direction of the pinned layer 210 or are opposed to the direction of the magnetic moments of the pinned layer 210, the current through the device is either high or low. The establishment of the moment direction in the free magnetic layer is used to store information in an MRAM cell. A plurality of cells can be arranged to form a memory array.

Although the foregoing technique is disclosed in the context of fabricating an MRAM device, the method steps may be used individually or in various combinations to form other structures. For example, a film stack comprising a layer of magnetic material may be etched by independently using steps 116 to 124 of FIG. 1B to pattern the layer using a hard mask and a BCl₃-based chemistry. Those skilled in the art will recognize that other combinations of the disclosed steps may be used to form various patterns, features, and structures.

One illustrative embodiment of an etch reactor that can be used to perform the etching step(s) of the present invention is depicted in FIG. 3.

FIG. 3 depicts a schematic diagram of the DPS II etch reactor 300 that may be uses to practice the inventive method. The process chamber 310 comprises at least one inductive coil antenna segment 312, positioned exterior to a dielectric ceiling 320. Other modifications may have other types of ceilings, e.g., a dome-shaped ceiling. The antenna segment 312 is coupled to a radio-frequency (RF) source 318 that is generally capable of producing an RF signal having a tunable frequency of about 50 kHz and 13.56 MHz. The RF source 318 is coupled to the antenna 312 through a matching network 319. Process chamber 310 also includes a wafer support pedestal (cathode) 316 that is coupled to a source 322 that is generally capable of producing an RF signal having a frequency of approximately 13.56 MHz. The source 322 is coupled to the cathode 316 through a matching network 324. Optionally, the source 322 may be a DC or pulsed DC source. The chamber 310 also contains a conductive chamber wall 330 that is connected to an electrical ground 334. A controller 340 comprising a central processing unit (CPU) 344, a memory 342, and support circuits 346 for the CPU 344 is coupled to the various components of the DPS etch process chamber 310 to facilitate control of the etch process.

In operation, the semiconductor wafer 314 is placed on the wafer support pedestal 316 and gaseous components are supplied from a gas panel 338 to the process chamber 310 through entry ports 326 to form a gaseous mixture 350. The gaseous mixture 350 is ignited into a plasma 355 in the process chamber 310 by applying RF power from the RF sources 318 and 322 respectively to the antenna 312 and the cathode 316. The pressure within the interior of the etch chamber 310 is controlled using a throttle valve 327 situated between the chamber 310 and a vacuum pump 336. The temperature at the surface of the chamber walls 330 is controlled using liquid-containing conduits (not shown) that are located in the walls 330 of the chamber 310.

The temperature of the wafer 314 is controlled by stabilizing the temperature of the support pedestal 316 and flowing helium gas from source 348 to channels formed by the back of the wafer 314 and grooves (not shown) on the pedestal surface. The helium gas is used to facilitate heat transfer between the pedestal 316 and the wafer 314. During the processing, the wafer 314 is heated by a resistive heater within the pedestal to a steady state temperature and the helium facilitates uniform heating of the wafer 314. Using thermal control of both the ceiling 320 and the pedestal 316, the wafer 314 is maintained at a temperature of between 0 and 500 degrees Celsius. The RF power applied to the inductive coil antenna 312 has a frequency between 50 kHz and 13.56 MHz and has a power of 200 to 3000 Watts. The bias power of between 0 and 300 Watts is applied to the pedestal 316 may be in a form of a DC, pulsed DC, or RF power.

To facilitate control of the chamber as described above, the CPU 344 may be one of any form of general purpose computer processor that can be used in an industrial setting for controlling various chambers and sub-processors. The memory 342 is coupled to the CPU 344. The memory 342, or computer-readable medium, may be one or more of readily available memory such as random access memory (RAM), read only memory (ROM), floppy disk, hard disk, or any other form of digital storage, local or remote. The support circuits 346 are coupled to the CPU 344 for supporting the processor in a conventional manner. These circuits include cache, power supplies, clock circuits, input/output circuitry and subsystems, and the like. The inventive method is generally stored in the memory 342 as software routine. The software routine may also be stored and/or executed by a second CPU (not shown) that is remotely located from the hardware being controlled by the CPU 344.

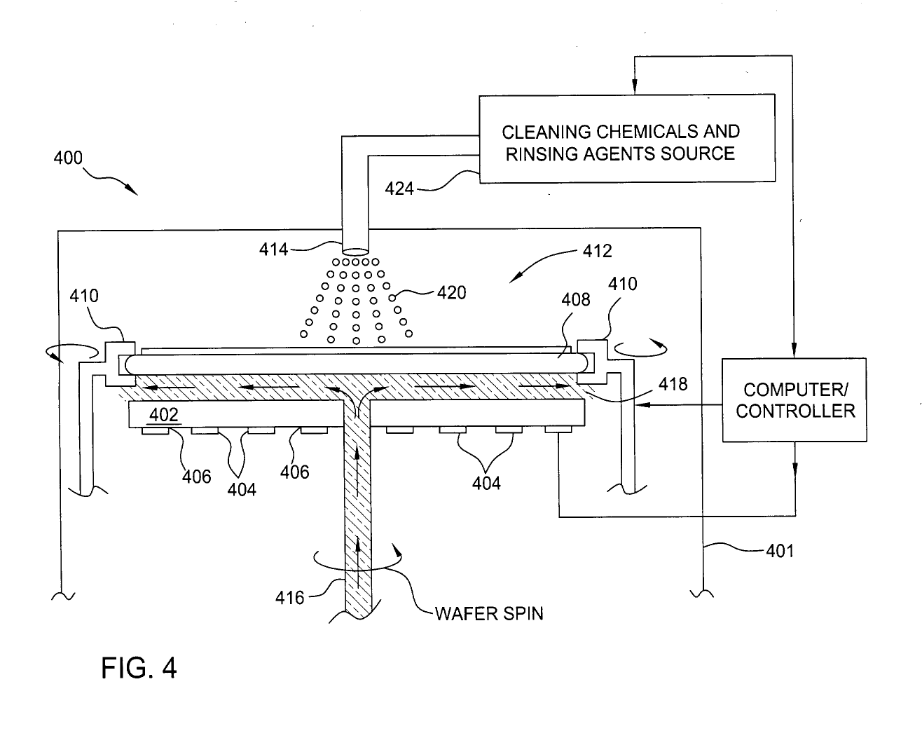

One illustrative embodiment of an apparatus that can be used for cleaning and rinsing a substrate in accordance with the present invention is a single substrate wet cleaning module. FIG. 4 depicts a simplified cross-sectional view of an illustrative embodiment of a single substrate wet cleaning module 400. The module 400 is described in detail in U.S. patent application Ser. No. 09/1945,454, filed Aug. 31, 2001 (attorney docket number 4936), which is herein incorporated by reference.

The module 400 applies cleaning chemicals and/or rinsing agents to the top and bottom of a substrate. To enhance the cleaning process, the module 400 uses acoustic or sonic waves to agitate the cleaning chemicals and/or rinsing agents.

The module 400 comprises a chamber 401, a nozzle 414, and a substrate support 412. The substrate support is mounted within the chamber 401 and comprises edge claps 410, plate 402 and a plurality of acoustic or sonic transducers 404. The plate 402 has a shape that is substantially the same as a substrate and supports the plurality of acoustic or sonic transducers 404. The plate 402 is, for example, made of aluminum, but can be formed of other materials such as, but not limited to, stainless steel and sapphire. The plate 402 is coated with a corrosion resistant fluoropolymer such as HALAR or PFA. The transducers 404 are attached to the bottom of the plate 402 using an adhesive, for example, an epoxy 406. In one embodiment of the cleaning module 400, the transducers 404 are arranged in an array that covers substantially the entire bottom surface of plate 402, e.g., approximately 80% of plate 402. The transducers generate sonic waves in the frequency range between 400 kHz and 8 MHz. In one embodiment of the module 400, the transducers are piezoelectric devices.

The plurality of edge clamps 410 retain the substrate 408 face up above the plate 402 to form a gap 418 between the backside of the wafer and the top surface of the plate 402. The gap 418 is approximately 3 mm. Cleaning chemicals and/or rinsing agents are provides to the gap via channel 416. The clamps are rotated to cause the substrate 408 to rotate about its central axis at a rate between 0 and 6000 rpm. In this embodiment of the module 400, the substrate 408 and clamps 410 rotate, while the plate 402 is stationary.

The nozzle 414 sprays cleaning chemicals and/or rinsing agents upon the top of the substrate 408 (i.e., the surface of the substrate comprising features, transistors, or other circuitry). As the nozzle 414 sprays the top of the substrate 408, the same or different cleaning chemicals and/or rinsing agents are supplied to the gap 418 via channel 416 as the substrate is rotated such that the cleaning chemicals and/or rinsing agents flow across the top and bottom surfaces of the substrate.

The nozzle 414 and channel 416 are coupled to a source 424 of cleaning chemicals and/or rinsing agents. The source 424 may be the same for the nozzle 414 and channel 416, or a separate source may be couple to each of the nozzle 414 and channel 416. In the present embodiment of the invention, the module 400 is used to clean the substrate 408 using hydrogen fluoride, ammonium fluoride, hydrogen peroxide, ammonium hydroxide and deionized water. The module 400 is further used to rinse the substrate in deionized water.

A computer controller 426 is generally used to control the operation of the module 400. Specifically, the computer controller 426 controls the rotation of the substrate support 412, the activation of the transducers 404, the supply of cleaning chemicals and/or rinsing agents, and so on.

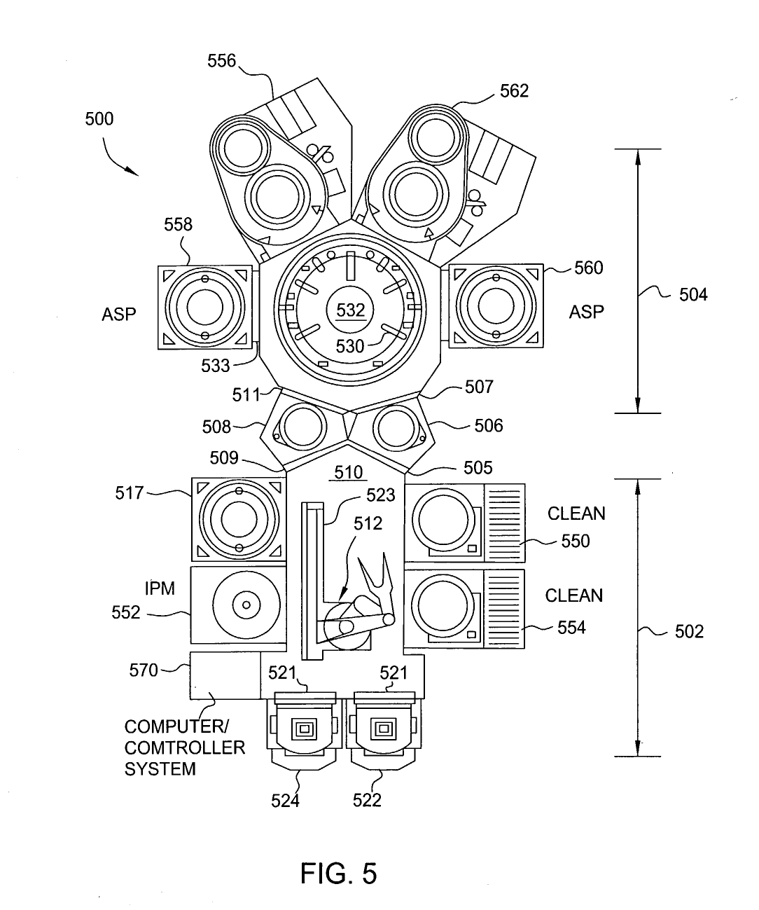

The method 100 of the present invention is illustratively performed on an integrated processing platform 500 shown in FIG. 5 that comprises apparatus for performing both atmospheric and sub-atmospheric processing. The platform 500 and the various modules and tools that can be used with such a platform are described in detail in U.S. patent application Ser. No. 09/945,454, filed Aug. 31, 2001 (attorney docket number 4936), which is herein incorporated by reference.

Depending upon the process modules that are used in the platform 500, the platform 500 (also referred to as a process tool) can be used to perform etching, oxidation, substrate cleaning, photoresist stripping, substrate inspection and the like. The platform 500 comprises an atmospheric platform 502 and a sub-atmospheric platform 504. The sub-atmospheric platform 504 and the atmospheric platform 502 may be coupled together by a single substrate load lock 506 or, as shown in the depicted example, are coupled together by a pair of single load locks 506 and 508. In some applications, the sub-atmospheric and atmospheric platforms 504 and 502 are not coupled together and may be used separately. In one configuration, the stand-alone platform 502 may contain photoresist stripping modules and wet cleaning modules that perform post-etch processing.

The atmospheric platform 502 comprises a central atmospheric transfer chamber 510 containing a substrate handling device 512, such as a robot. Directly attached to the atmospheric transfer chamber 510 is a substrate wet cleaning module 550, an integrated particle monitor 552 and a critical dimension (CD) measuring tool 554, and a photoresist stripping chamber 517. A dry clean module (not shown) can also be attached to the atmospheric transfer chamber 510, if desired. Each module or tool is coupled to the transfer chamber 510 by a separately closable and sealable opening, such as a slit valve. The transfer chamber is maintained at substantially atmospheric pressure during operation. The substrate handling device 512 is able to transfer substrates from one module or tool to another module or tool that is attached to the atmospheric transfer chamber 510. In the embodiment shown, the substrate handling device 512 is a dual blade, single arm, single wrist robot. Other types of robots may be used to access the various modules and tools.

The atmospheric transfer chamber 510 is coupled to at least one substrate input/output module 520 that provides and receives substrates to and from the platform 500. In one embodiment of the platform 500, the module 520 comprises at least one front opening unified pod (FOUP). Two FOUPs 522 and 524 are depicted. The substrate handling device 512 accesses each FOUP through a sealable access door 521. The substrate handling device 512 moves linearly along a track 523 to facilitate access to all of the modules and tools.

The atmospheric transfer chamber 510 is coupled to the pair of load locks 506 and 508 through sealable doors 505 and 509 such that the substrate handling device 512 can access the load locks 506 and 508. The sub-atmospheric platform 504 comprises a central sub-atmospheric transfer chamber 530 and a plurality of process chambers 556, 558, 560, and 562. Sealable doors 507 and 511 respectively couple each load lock 506 and 508 to the sub-atmospheric transfer chamber 530. The sub-atmospheric transfer chamber 530 contains a substrate handing device 532, such as a robot (not shown), that accesses the load locks 506 and 508 as well as the process chambers 556, 558, 560 and 562. The process chambers 556, 558, 560 and 562 are each coupled to the sub-atmospheric transfer chamber 530 via separately closable and sealable openings, such as slit-valves. The process chambers 556, 558, 560 and 562 may comprise one or more etching chambers such as the DPS or DPS II chamber. Additionally, one or more photoresist stripping chambers such as the ASP chamber described above may be used as one or more of the process chambers 556, 558, 560 and 562. As also described above, the ASP chamber, if used, may be located either on the sub-atmospheric platform 504 or the atmospheric platform 502. FIG. 5 shows the sub-atmospheric platform 504 comprising two etch and oxidation chambers 558 and 560 and two photoresist stripping chambers 556 and 562. The sub-atmospheric platform 504 is, for example, a CENTURA platform available from Applied Materials, Inc. of Santa Clara, Calif.

The platform 500 also includes a system computer 570 that is coupled to and controls each module that is coupled to the atmospheric and sub-atmospheric platforms 502 and 504, controls the substrate handling devices 512 and 532, and controls the load locks 506 and 508. Generally, the system computer 570 controls all aspects of operation of the platform 500 either by direct control of the sub-systems, modules, tools and apparatus or by controlling the computers associated with those sub-systems, modules, tools and apparatus. The system computer 570 enables feedback from one module or tool to be used to control the flow of substrates through the platform 500 and/or control the processes or operation of the various modules and tools to optimize substrate throughput.

Although the forgoing discussion referred to fabrication of the MRAM device, fabrication of the other devices and features used in the integrated circuits can benefit from the invention. The invention can be practiced in other etch semiconductor processing systems wherein the processing parameters may be adjusted to achieve acceptable characteristics by those skilled in the art by utilizing the teachings disclosed herein without departing from the spirit of the invention.

While foregoing is directed to the preferred embodiment of the present invention, other and further embodiments of the invention may be devised without departing from the basic scope thereof, and the scope thereof is determined by the claims that follow.

What is claimed is:

1. A method of etching a film stack comprising a layer of magnetic material, said method comprising:
(a) forming a hard mask upon the film stack; and
(b) etching the layer of magnetic material using a plasma comprising BCl₃.

2. The method of claim 1 wherein:
the magnetic material comprises at least one of NiFe, Ru, CoFe, PtMn, NiFe, or NiFeCr.

3. The method of claim 1 wherein the layer of magnetic material is a free magnetic layer of an magneto-resistive random access memory (MRAM) film stack.

4. The method of claim 1 wherein step (b) comprises:
supplying 5 to 25 sccm of BCl₃ and 20 to 100 sccm of Ar, maintaining a gas pressure between 5 and 40 mTorr, applying a bias power to a cathode electrode of between 0 and 300 Watt, applying power to an inductively coupled antenna of between 200 and 3000 Watt, and maintaining the substrate at a temperature of between 15 and 80 degrees Celsius.

5. The method of claim 1 wherein step (b) comprises:
supplying 20 sccm of BCl₃ and 80 sccm of Ar, maintaining a gas pressure at 5 mTorr, applying a bias power to a cathode electrode about 150 Watt, applying power to an inductively coupled antenna about 700 Watt, and maintaining the substrate at a temperature about 80 degrees Celsius.

6. A method of fabricating a magneto-resistive random access memory device from a film stack comprising a top electrode, a free magnetic layer, a tunnel layer, a magnetic film stack, and a bottom electrode, that are formed on a semiconductor substrate, comprising:
(a) forming a first sacrificial hard mask;
(b) etching the top electrode wherein said etching of the top electrode produces a first residue;
(c) etching the free magnetic layer;
(d) removing a first residue and a first sacrificial hard mask;
(e) forming a second sacrificial hard mask on the top electrode;
(f) etching the tunnel layer and the magnetic film stack;
(g) etching the bottom electrode layer; and
(h) removing a second residue.

7. The method of claim 6 wherein:
the first and the second sacrificial hard masks comprise SiO₂;
the top electrode comprises at least one of Ta or TaN;
the free magnetic layer comprises at least one of NiFe or CoFe;
the tunnel layer comprises Al₂O₃;
the magnetic film stack comprises at least one of NiFe, Ru, CoFe, PtMn, NiFe, NiFeCr; and
the bottom electrode comprises at least one of Ta or TaN.

8. The method of claim 6 wherein step (a) further comprises:
(a1) depositing a layer of material that is used to form the first sacrificial hard mask on the top electrode;
(a2) forming a photoresist etch mask defining the first sacrificial hard mask; and
(a3) forming the first sacrificial hard mask.

9. The method of claim 8 wherein the photoresist etch mask comprises a layer of anti-reflective coating.

10. The method of claim 8 wherein step (a3) and step (b) are performed sequentially in the same reactor.

11. The method of claim 8 wherein step (a3) is performed using the same etching chemistry as step (b).

12. The method of claim 6 wherein step (b) uses a plasma comprising CF₄, CHF₃, and Ar.

13. The method of claim 6 wherein step (b) comprises:
supplying about 40 to 80 sccm of CF₄, 10 to 30 sccm of CHF₃, and 40 to 80 sccm of Ar, maintaining in a reaction chamber a gas pressure at about 5 to 40 mTorr, applying a bias power to a cathode electrode of about 0 to 300 Watt, applying power to an inductively coupled antenna of about 200 to 3000 Watt, and maintaining the substrate at a temperature of about 15 to 80 degrees Celsius.

14. The method of claim 6 wherein step (b) further comprises a step of:
stripping an etch mask.

15. The method of claim 14 wherein the stripping step is performed after forming the first sacrificial hard mask and etching the top electrode.

16. The method of claim 14 wherein the stripping step uses a plasma comprising O₂.

17. The method of claim 6 wherein step (c) further comprises:
(c1) etching the free magnetic layer in a plasma comprising an oxygen and chlorine.

18. The method of claim 17 wherein step (c1) uses the plasma comprising Cl₂, O₂, and Ar.

19. The method of claim 17 wherein step (c1) comprises:
supplying 30 to 50 sccm of Cl₂, 10 to 30 sccm of O₂, and 10 to 30 sccm of Ar, maintaining a gas pressure of about 5 to 40 mTorr, applying a bias power to a cathode electrode of about 0 to 300 Watt, applying power to an inductively coupled antenna of about 200 to 3000 Watt, and maintaining the substrate at a temperature of about 15 to 85 degrees Celsius.

20. The method of claim 6 wherein step (d) further comprises:
applying a solution comprising HF, NH₄F, and deionized water until the residue that is present on the substrate after step (c) is removed; and
rinsing the substrate in distilled water.

21. The method of claim 20 wherein the solution comprises between 1 and 49% of HF by volume and applied at a temperature of about 10 to 30 degrees Celsius for a duration of about 10 to 120 seconds.

22. The method of claim 6 wherein step (e) further comprises:
(e1) depositing a layer of material that is used to form the second sacrificial hard mask on the top electrode;
(e2) forming a photoresist etch mask defining the second sacrificial hard mask; and
(e3) etching the second sacrificial hard mask in a plasma comprising chlorine or fluorine.

23. The method of claim 22 wherein the photoresist etch mask comprises a layer of anti-reflective coating.

24. The method of claim 22 wherein step (e3) uses the plasma comprising CF₄, CHF₃, and Ar.

25. The method of claim 22 wherein step (e3) comprises:
supplying about 40 to 80 sccm of CF₄, 10 to 30 sccm of CHF₃, and 40 to 80 sccm of Ar, maintaining in a reaction chamber a gas pressure at about 5 to 40 mTorr, applying a bias power to a cathode electrode of about 0 to 300 Watt, applying power to an inductively coupled antenna of about 200 to 3000 Watt, and maintaining the substrate at a temperature of about 15 to 80 degrees Celsius.

26. The method of claim 6 wherein step (f) further comprises:
(f1) etching of the magnetic film stack in a plasma comprising BCl₃.

27. The method of claim 26 wherein step (f1) uses the plasma comprising BCl₃ and Ar.

28. The method of claim 26 wherein step (f1) comprises:
supplying 5 to 25 sccm of BCl₃ and 20 to 100 sccm of Ar, maintaining a gas pressure of about 5 to 40 mTorr, applying a bias power to a cathode electrode of about 0 to 300 Watt, applying power to an inductively coupled antenna of about 200 to 3000 Watt, and maintaining the substrate at a temperature of about 15 to 80 degrees Celsius.

29. The method of claim 6 wherein step (g) is performed using the same etching chemistry as step (f).

30. The method of claim 6 wherein step (f) and step (g) are performed in the same reactor.

31. The method of claim 6 wherein step (f), step (g), and step (h) are performed in the same reactor.

32. The method of claim 6 wherein a step (g) further comprises:
(g1) etching the bottom electrode layer in a plasma comprising Cl₂.

33. The method of claim 32 wherein step (g1) uses the plasma comprising Cl₂ and Ar.

34. The method of claim 32 wherein step (g1) comprises:
supplying 10 to 100 sccm of Cl₂ and 10 to 100 sccm of Ar, maintaining a gas pressure of about 5 to 40 mTorr, applying a bias power to a cathode electrode of about 0 to 300 Watt, applying power to an inductively coupled antenna of about 200 to 3000 Watt, and maintaining the substrate at a temperature of about 15 to 80 degrees Celsius.

35. The method of claim 6 wherein step (h) further comprises:
applying a solvent comprising NH₄OH, H₂O₂, and H₂O to the substrate until a residue that is present on the substrate after step (b) is removed; and
rinsing the substrate in distilled water.

36. The method of claim 35 wherein the solvent comprises, by weight, about (0.1-10) parts of NH₄OH, (0.1-10) parts of H₂O₂, and (1-100) parts of H₂O, and is applied at a temperature of about 45 to 65 degrees Celsius for a duration of about 30 to 120 seconds.

37. The method of claim 35 wherein the solvent comprises, by weight, 1 part of NH₄OH, 10 part of H₂O₂, and 10 parts of H₂O, and is applied at a temperature of about 45 to 65 degrees Celsius for a duration of about 30 to 120 seconds.

38. The method of claim 6 wherein step (h) further comprises:
(h1) removing the second sacrificial hard mask;
(h2) removing the barrier layer outside a perimeter of the bottom electrode; and
(h3) rinsing the substrate in distilled water.

39. The method of claim 38 wherein step (h1) and step (h2) are performed simultaneously in the same reactor.

40. The method of claim 38 wherein step (h2) is performed using the same chemistry as step (h1).

41. The method of claim 38 wherein step (h1) further comprises:
applying a solution comprising HF, NH₄F, and deionized water.

42. The method of claim 41 wherein the solution comprises between 1 and 49% of HF by volume and applied at a temperature of about 10 to 30 degrees Celsius for a duration of about 10 to 120 seconds.
